(19) United States
(12) Patent Application Publication
(10) Pub. No.: US 2025/0242869 A1
(43) Pub. Date: Jul. 31, 2025

(54) VEHICLE BODY STRUCTURE MEMBER

(71) Applicant: TOYOTA JIDOSHA KABUSHIKI KAISHA, Toyota-shi (JP)

(72) Inventor: Tatsuroh MOTOYA, Toyota-shi (JP)

(73) Assignee: TOYOTA JIDOSHA KABUSHIKI KAISHA, Toyota-shi (JP)

(21) Appl. No.: 18/926,906

(22) Filed: Oct. 25, 2024

(30) Foreign Application Priority Data
Jan. 30, 2024 (JP) 2024-012282

(51) Int. Cl. B62D 27/02; B62D 25/02; B62D 25/04; B62D 25/20

(52) U.S. Cl. CPC B62D 27/023; B62D 25/025; B62D 25/04; B62D 25/2036

(57) ABSTRACT

The rocker is divided into front and rear parts of the vehicle, and includes a rocker front part and a rocker rear part, and the coupling member is coupled to the rocker front part, the rocker rear part, the center pillar, and the floor cross member in a state of being covered from the outside. Further, the coupling member is provided with a rib protruding along the extending direction of the floor cross member between the third coupling portion and the fourth coupling portion. Thus, the rigidity of the coupling member itself can be improved. Further, the angle made by the rocker, the center pillar, and the floor cross member is maintained, and it is possible to suppress the deformation of the floor cross member in the vehicle vertical direction due to the road surface input during the traveling of the vehicle.

### CROSS-REFERENCE TO RELATED APPLICATION

This application claims priority to Japanese Patent Application No. 2024-012282 filed on Jan. 30, 2024, incorporated herein by reference in its entirety.

### BACKGROUND

### 1. Technical Field

The present disclosure relates to a vehicle body structure member.

### 2. Description of Related Art

Japanese Unexamined Patent Application Publication No. 07-267139 (JP 07-267139 A) discloses a technique relating to a vehicle body structure of an automobile, in which at least one of an inner frame and an outer frame is made of a cast material, and the inner frame and the outer frame are joined to provide an intersection portion of the frames with a closed cross section.

In this related art, further, a rib is provided to extend from one frame toward the other frame at the intersection portion of at least one of the inner frame or the outer frame so that the closed cross section is blocked by the rib, improving the rigidity of the intersection portion of the frames.

### SUMMARY

In a battery electric vehicle, on the other hand, when no tunneling portion extending in the vehicle front-rear direction is provided on the upper surface side of a floor panel and no reinforcement is provided on the lower surface side of the floor panel, the surface rigidity of the floor panel decreases. When the surface rigidity of the floor panel decreases, a floor cross member extending in the vehicle width direction on the upper surface side of the floor panel may be deformed in the vehicle up-down direction.

In view of the above, it is an object of the present disclosure to provide a vehicle body structure member capable of suppressing deformation of a floor cross member in the vehicle up-down direction.

A first aspect provides a vehicle body structure member including a coupling member disposed at an intersection portion of a rocker, a center pillar, and a floor cross member, the rocker being provided at an end portion of a floor panel in a vehicle width direction, extending in a vehicle front-rear direction, and configured to include a rocker front portion and a rocker rear portion divided in the vehicle front-rear direction, the center pillar extending in a vehicle up-down direction at a substantially central portion in the vehicle front-rear direction, the floor cross member extending along the vehicle width direction on the floor panel, and the coupling member being connectable to the rocker front portion, the rocker rear portion, the center pillar, and the floor cross member, in which the coupling member is configured to include: a first coupling portion provided at a front end portion of the coupling member in the vehicle front-rear direction and coupled to the rocker front portion in a state of covering a rear end portion of the rocker front portion in the vehicle front-rear direction from outside; a second coupling portion provided at a rear end portion of the coupling member in the vehicle front-rear direction and coupled to the rocker rear portion in a state of covering a front end portion of the rocker rear portion in the vehicle front-rear direction from outside; a third coupling portion provided at a center portion of the coupling member in the vehicle front-rear direction and an upper end portion of the coupling member in the vehicle up-down direction and coupled to the center pillar in a state of covering a lower end portion of the center pillar in the vehicle up-down direction from outside; a fourth coupling portion provided on a lower side in the vehicle up-down direction with respect to the third coupling portion and coupled to the floor cross member in a state of covering an end portion of the floor cross member in the vehicle width direction from outside; and a rib provided between the third coupling portion and the fourth coupling portion and protruding along an extending direction of the floor cross member.

The vehicle body structure member according to the first aspect includes the coupling member disposed at the intersection portion of the rocker, the center pillar, and the floor cross member. The rocker is configured to include the rocker front portion and the rocker rear portion divided in the vehicle front-rear direction, and the coupling member is connectable to the rocker front portion, the rocker rear portion, the center pillar, and the floor cross member.

Here, the coupling member is configured to include the first coupling portion, the second coupling portion, the third coupling portion, the fourth coupling portion, and the rib. The first coupling portion is provided at the front end portion of the coupling member, and coupled to the rocker front portion in the state of covering the rear end portion of the rocker front portion from outside. The second coupling portion is provided at the rear end portion of the coupling member, and coupled to the rocker rear portion in the state of covering the front end portion of the rocker rear portion from outside.

The third coupling portion is provided at the center portion of the coupling member in the vehicle front-rear direction and the upper end portion of the coupling member, and coupled to the center pillar in the state of covering the lower end portion of the center pillar from outside. The fourth coupling portion is provided on the lower side with respect to the third coupling portion, and coupled to the floor cross member in the state of covering the end portion of the floor cross member in the vehicle width direction from outside.

In the present disclosure, the rocker front portion, the rocker rear portion, the center pillar, the floor cross member, and the coupling member are coupled to each other with a part of the coupling member covering the other members from outside. Therefore, the rigidity can be improved as compared with a case where the end surfaces of the members are brought into abutment with each other to be welded, bonded, or the like at the intersection portion.

In the present disclosure, the rocker (the rocker front portion and the rocker rear portion), the center pillar, and the floor cross member are coupled to each other via the coupling member. Therefore, the rigidity can be improved at the intersection portion by adding the rigidity of the coupling member itself, as compared with a case where the coupling member is not provided.

In the present disclosure, further, the rib is provided between the third coupling portion and the fourth coupling portion. Accordingly, the rigidity of the coupling member itself can be improved. The rib protrudes along the extending direction of the floor cross member. Therefore, it is possible to suppress the floor cross member from being deformed toward the vehicle upper side, starting from the rocker side.

With the above-described configuration, in the present disclosure, the angles made by the rocker, the center pillar, and the floor cross member are kept, and it is possible to suppress the deformation of the floor cross member in the vehicle up-down direction due to input from the road surface during travel of the vehicle. By improving the rigidity of the floor cross member in this manner, the seat vibration is suppressed, the ride comfort is improved, and the steering stability is improved.

A second aspect provides the vehicle body structure member according to the first aspect, in which: the floor cross member has a cross section, when cut along a direction substantially orthogonal to the extending direction, in a substantially inverted U-shape that opens on a side of the floor panel; and the rib is provided on front and rear sides in the vehicle front-rear direction substantially along a ridge line of the floor cross member, and extends between the third coupling portion and the fourth coupling portion.

In the vehicle body structure member according to the second aspect, the floor cross member has a cross section, when cut along a direction substantially orthogonal to the extending direction, in a substantially inverted U-shape that opens on the side of the floor panel. That is, the floor cross member is configured to include a front wall portion that constitutes a front end in the vehicle front-rear direction, a rear wall portion that constitutes a rear end in the vehicle front-rear direction, and an upper wall portion that constitutes an upper end in the vehicle up-down direction, and a ridge line is provided at the boundary between the front wall portion and the upper wall portion and the boundary between the rear wall portion and the upper wall portion.

Here, the rib is provided on the front and rear sides in the vehicle front-rear direction substantially along the ridge line of the floor cross member, and extends between the third coupling portion and the fourth coupling portion. By providing the rib in this manner, it is possible to improve the rigidity of the coupling member itself.

By providing the rib along the ridge line, it is possible to effectively keep the angle between the third coupling portion and the fourth coupling portion, and it is possible to suppress the floor cross member from being deformed toward the vehicle upper side, starting from the rocker side.

A third aspect provides the vehicle body structure member according to the first aspect, in which a reinforcing member is provided inside the floor cross member including the third coupling portion, the reinforcing member being fastened together with the third coupling portion and the floor cross member.

In the vehicle body structure member according to the third aspect, the reinforcing member is provided inside the floor cross member including the third coupling portion, and the reinforcing member is fastened together with the third coupling portion and the floor cross member. This makes it possible to improve the rigidity of the floor cross member. Thus, according to the present disclosure, it is possible to suppress the deformation of the floor cross member in the vehicle up-down direction due to input from the road surface during travel of the vehicle, suppressing the seat vibration and improving the ride comfort. In addition, the steering stability is improved.

A fourth aspect provides the vehicle body structure member according to the first aspect, in which a solid portion is provided between the first coupling portion and the second coupling portion.

In the vehicle body structure member according to the fourth aspect, the solid portion is provided between the first coupling portion and the second coupling portion. Accordingly, the solid portion is provided in the rocker between the rocker front portion and the rocker rear portion. Therefore, it is possible to suppress collapse of the cross section of the rocker caused by the deformation of the floor cross member in the vehicle up-down direction.

By providing the solid portion in the coupling member coupled to the rocker, the center pillar, and the floor cross member, the path of intrusion of sound during travel of the vehicle is blocked, reducing high-frequency road noise. In addition, muffled sound is reduced with the reduction of sound generated from the floor panel. According to the present disclosure, a foaming agent that is used to reduce noise is not required, and accordingly the cost can be reduced.

As described above, the vehicle body structure member according to the present disclosure can suppress deformation of the floor cross member in the vehicle up-down direction.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating a state in which a coupling member constituting a vehicle body structure member according to an embodiment is coupled to a rocker, a center pillar, and a floor cross member;

FIG. 2 is a perspective view illustrating a coupling member constituting the vehicle body structure member according to the embodiment;

FIG. 3 is a side view, viewed from the inside in the vehicle width direction, illustrating a state in which the coupling member constituting the vehicle body structure member according to the embodiment is coupled to the rocker, the center pillar, and the floor cross member;

FIG. 4 is an end view taken along IV-IV shown in FIG. 1;

FIG. 5 is an end view taken along V-V shown in FIG. 1;

FIG. 6 is an end view taken along VI-VI line shown in FIG. 1; and

FIG. 7 is an operation diagram for explaining an operation of the vehicle to which the vehicle body structure member according to the embodiment is applied.

### DETAILED DESCRIPTION OF EMBODIMENTS

Hereinafter, a vehicle body structure member according to the present disclosure will be described with reference to the drawings. Furthermore, in the drawings, an arrow FR indicates a vehicle front side, an arrow UP indicates a vehicle upper side, and an arrow RH indicates a right side of the width direction of the vehicle. Hereinafter, in the case of simply describing the front-rear direction, the up-down direction, and the left-right direction, the left-right direction in the vehicle width direction when the vehicle is directed in the front-rear direction, the up-down direction, and the traveling direction in the vehicle front-rear direction, unless otherwise specified, is assumed to be indicated.

### Structure of Vehicle Body Structure Member

First, a configuration of a vehicle body structure member according to the present embodiment will be described.

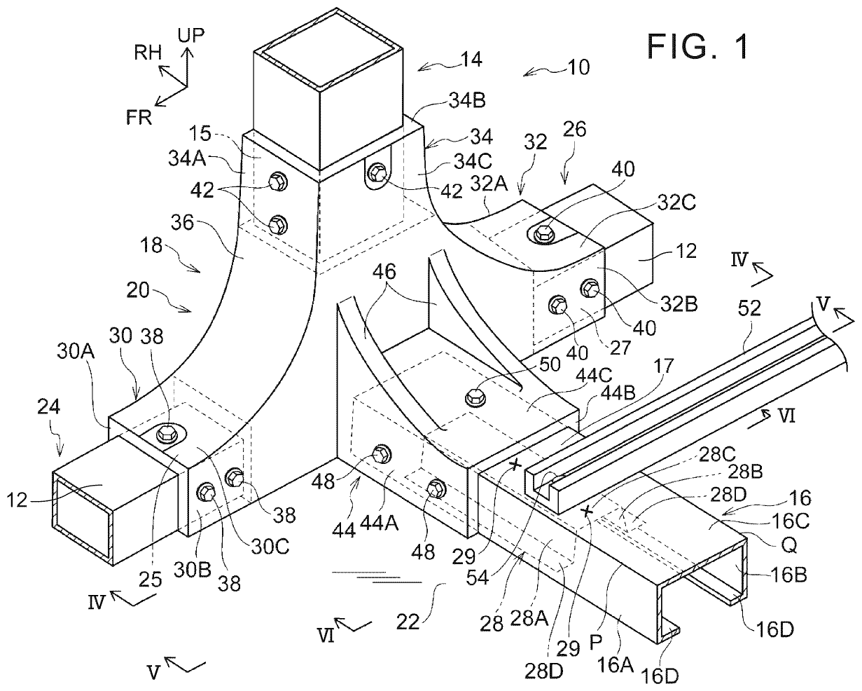

The vehicle to which the vehicle body structure member 10 shown in FIG. 1 is applied is not shown. Vehicles to which the vehicle body structure member 10 shown in FIG. 1 is applied are a battery electric vehicle and a fuel cell electric vehicle that travel with power generated by a power unit. In addition, the vehicle body structure member 10 according to the present embodiment includes a coupling member 20 disposed at an intersection portion 18 between the rocker 12, the center pillar 14, and the floor cross member 16.

The rocker 12 extends in the vehicle front-rear direction at both end portions in the vehicle width direction of the floor panel 22 constituting the floor portion in the vehicle cabin. A pair of left and right rockers 12 are provided, and a battery is disposed inside the pair of left and right rockers 12 in the vehicle width direction, although not shown.

Further, the rocker 12 is divided into front and rear parts of the vehicle, and includes a rocker front portion 24 and a rocker rear portion 26. The rocker 12 has a closed cross-sectional structure in which a cross-sectional shape cut substantially perpendicularly to the extending direction forms a substantially rectangular shape. The rocker 12 is formed by, for example, extrusion molding, and in the present embodiment, is formed by, for example, an extruded material of an aluminum alloy.

Incidentally, the rocker 12, although not shown, may be constituted by an outer panel disposed outside the vehicle width direction, and an inner panel constituting the closed cross-sectional structure between the outer panel disposed inside the vehicle width direction. In this case, the outer panel and the inner panel are press-formed with a steel plate or the like.

On the other hand, the center pillar 14 extends in the vehicle vertical direction at a substantially central portion in the vehicle front-rear direction. The center pillar 14 includes, for example, an outer panel disposed outside the vehicle width direction, and an inner panel disposed inside the vehicle width direction and forming a closed cross-sectional structure having a substantially rectangular cross-sectional shape with respect to the outer panel, although not illustrated. A plate-shaped reinforcement may be provided between the outer panel and the inner panel.

Further, the floor cross member 16 extends along the vehicle width direction on the floor panel 22. The floor cross member 16 has a substantially inverted U-shape in which a cross-sectional shape cut along a direction substantially orthogonal to the extending direction is an opening on the floor panel 22 side. The floor cross member 16 is formed by, for example, extrusion molding, and is formed by an extruded material of an aluminum alloy.

The floor cross member 16 includes a front wall portion 16A, a rear wall portion 16B, and an upper wall portion 16C that constitutes an upper end of the floor cross member 16 and connects an upper end of the front wall portion 16A and an upper end of the rear wall portion 16B. The front wall portion 16A constitutes the front end of the floor cross member 16. The rear wall portion 16B constitutes the rear end of the floor cross member 16. In the floor cross member 16, a ridge line P is provided at a boundary between the front wall portion 16A and the upper wall portion 16C, and a ridge line Q is provided at a boundary between the rear wall portion 16B and the upper wall portion 16C.

Further, the lower end of the front wall portion 16A and the rear wall portion 16B, the joining piece 16D is provided to bend toward each other, the joining piece 16D abuts on the upper surface of the floor panel 22 can be joined by spot-welding or the like.

Further, a bulk (reinforcing member) 28 is provided in the floor cross member 16 at the end portion 17 of the floor cross member 16. Bulk 28 is formed along the extending direction of the floor cross member 16, as shown in FIG. 6, the cross-sectional shape cut along a direction substantially orthogonal to the extending direction is substantially hat-shaped opening the floor panel 22 side. Note that FIG. 6 is an end view when cut along VI-VI shown in FIG. 1.

The bulk 28 includes a front wall portion 28A, a rear wall portion 28B, and an upper wall portion 28C that is in contact with the upper wall portion 16C of the floor cross member 16 and is spot-welded (welded portion 29). The front wall portion 28A faces the front wall portion 16A of the floor cross member 16. The rear wall portion 28B faces the rear wall portion 16B of the floor cross member 16.

Further, the lower ends of the front wall portion 16A and the rear wall portion 16B are provided with a joint piece 28D that is bent toward a distance from each other. The joint piece 28D can be joined to the joining piece 16D of the floor cross member 16 by arc-welding (the welded portion 31) or the like.

### Coupling Member

Here, the coupling member 20 will be described.

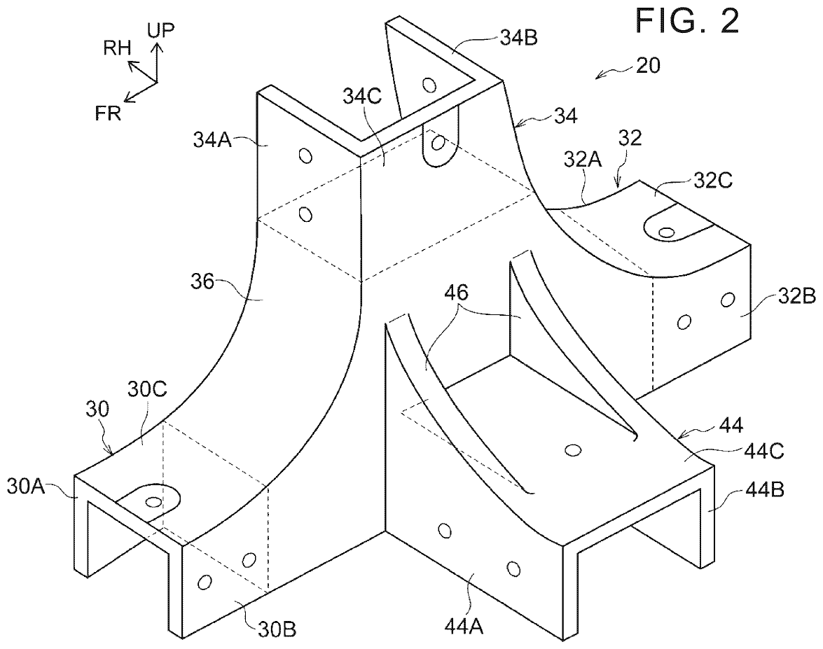

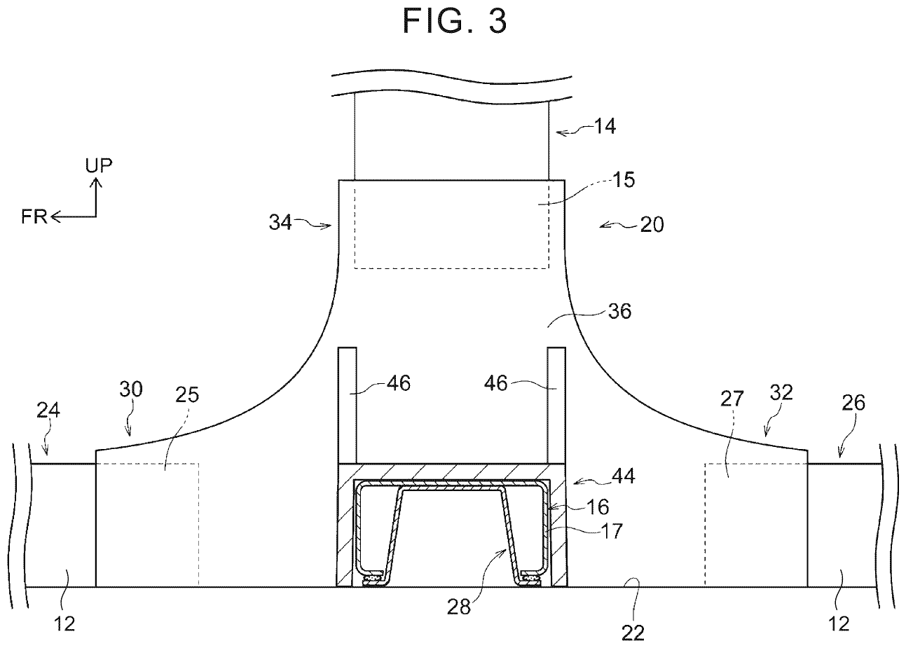

The coupling member 20 illustrated in FIG. 2 is, for example, a cast member cast using an aluminum alloy, a magnesium alloy, or the like as a material. As shown in FIG. 3, the coupling member 20 has a substantially triangular shape in which the top portions are cut off in a vehicle side view, and is disposed between the rocker front portion 24 and the rocker rear portion 26.

As shown in FIGS. 1 and 2, a first coupling portion 30 is provided at a front end portion of the coupling member 20. The first coupling portion 30 has a substantially U-shape having an opening on the lower side. The first coupling portion 30 is configured to include an outer wall 30A provided on the outer side in the vehicle width direction, an inner wall 30B provided on the inner side in the vehicle width direction, which is capable of facing the outer wall 30A, and an upper wall portion 30C connecting the upper end of the outer wall 30A and the upper end of the inner wall 30B. Therefore, the first coupling portion 30 can be covered from the outside with respect to the rear end portion 25 of the rocker front portion 24.

Further, a second coupling portion 32 is provided at a rear end portion of the coupling member 20. The second coupling portion 32 has a substantially U-shape having an opening on the lower side. The second coupling portion 32 includes an outer wall 32A provided on the outer side in the vehicle width direction, an inner wall 32B provided on the inner side in the vehicle width direction, which is capable of facing the outer wall 32A, and an upper wall portion 32C connecting the upper end of the outer wall 32A and the upper end of the inner wall 32B. Therefore, the second coupling portion 32 can be covered from the outside with respect to the front end portion 27 of the rocker rear portion 26.

Further, a third coupling portion 34 is provided at a center portion and an upper end portion of the coupling member 20 in the vehicle front-rear direction. The third coupling portion 34 has a substantially U-shape having an opening on the outside of the vehicle. The third coupling portion 34 includes a front wall portion 34A provided on the front side in the vehicle front-rear direction, a rear wall portion 34B provided on the rear side in the vehicle front-rear direction and capable of facing the front wall portion 34A, and an inner wall portion 34C connecting the inner end of the front wall portion 34A and the inner end of the rear wall portion 34B. Therefore, the third coupling portion 34 can be covered from the outside with respect to the lower end portion 15 of the center pillar 14.

On the other hand, a portion between the first coupling portion 30 and the second coupling portion 32 of the coupling member 20 and the lower side of the third coupling portion 34 is a solid portion 36.

Therefore, in a state in which the first coupling portion 30 of the coupling member 20 is covered from the outside with respect to the rear end portion 25 of the rocker front portion 24, the rear end of the rocker front portion 24 is positioned in a state of being in contact with the solid portion 36. In this state, the rear end portion 25 of the rocker front portion 24 is fastened (coupled) to the first coupling portion 30 by a bolt 38 via a weld nut (not shown) or the like.

Further, in a state in which the second coupling portion 32 of the coupling member 20 is covered from the outside with respect to the front end portion 27 of the rocker rear portion 26, the front end of the rocker rear portion 26 is positioned in a state of being in contact with the solid portion 36. In this state, the front end portion 27 of the rocker rear portion 26 is fastened to the second coupling portion 32 by the bolt 40.

Further, in a state where the third coupling portion 34 of the coupling member 20 is covered from the outside with respect to the lower end portion 15 of the center pillar 14, the lower end of the center pillar 14 is positioned in a state of being in contact with the solid portion 36. In this state, the lower end portion 15 of the center pillar 14 is fastened to the third coupling portion 34 by the bolt 42.

A fourth coupling portion 44 extends inward in the vehicle width direction at a center portion of the coupling member 20 in the vehicle front-rear direction and a lower side of the third coupling portion 34. The fourth coupling portion 44 has a substantially U-shape having an opening on the lower side. The fourth coupling portion 44 includes a front wall portion 44A provided on the front side in the vehicle front-rear direction, a rear wall portion 44B provided on the rear side in the vehicle front-rear direction and capable of facing the front wall portion 44A, and an upper wall portion 44C connecting the upper end of the front wall portion 44A and the upper end of the rear wall portion 44B. Therefore, the fourth coupling portion 44 can be covered from the outside with respect to the end portion 17 of the floor cross member 16.

Further, a pair of ribs 46 is provided along the vehicle width direction between the third coupling portion 34 and the fourth coupling portion 44. The rib 46 extends so as to span the third coupling portion 34 and the fourth coupling portion 44 substantially along the ridge lines P and Q of the floor cross member 16 in a state where the end portion 17 of the floor cross member 16 is covered from the outside by the fourth coupling portion 44.

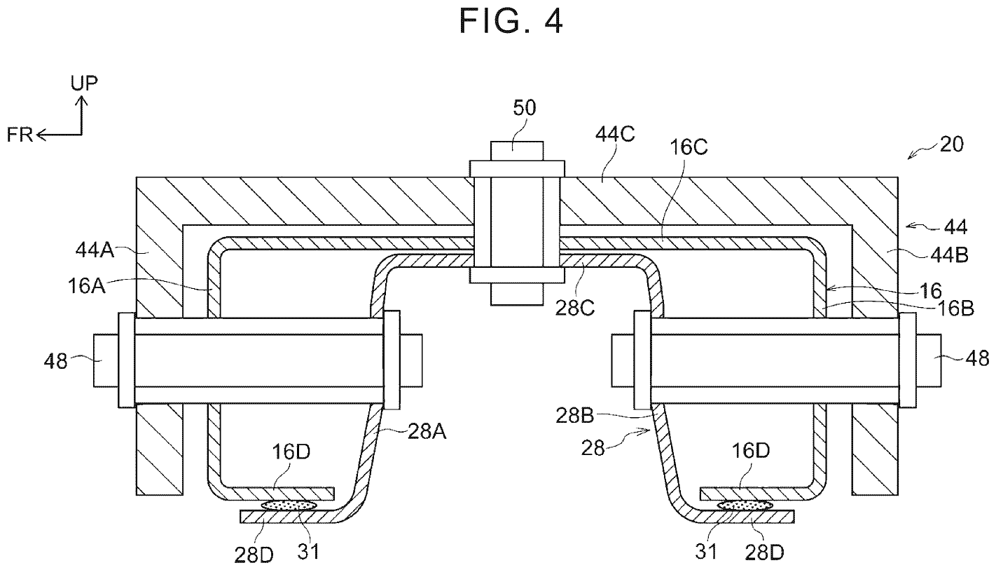

Then, in a state where the fourth coupling portion 44 of the coupling member 20 is covered from the outside with respect to the end portion 17 of the floor cross member 16, as shown in FIG. 4, the end portion 17 of the floor cross member 16 is fastened to the fourth coupling portion 44 by bolts 48 and 50. FIG. 4 is an end view taken along IV-IV shown in FIG. 1.

Here, as described above, at the end portion 17 of the floor cross member 16, the bulk 28 is provided inside the floor cross member 16. Therefore, the floor cross member 16 and the bulk 28 are fastened to the fourth coupling portion 44.

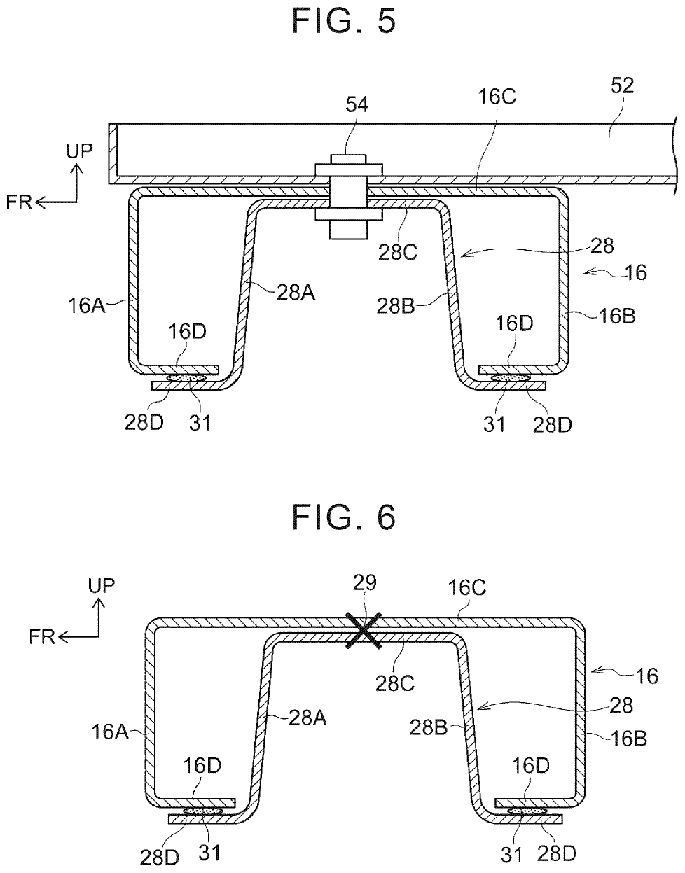

As shown in FIG. 1, a seat rail 52 that allows the vehicle seat to slide is mounted on the end portion 17 of the floor cross member 16. Thus, as shown in FIG. 5, the seat rail 52 is secured to the floor cross member 16 and the bulk 28 via bolts 54. FIG. 5 is an end view taken along V-V shown in FIG. 1.

### Action and Effect of Vehicle Body Structure Member

Next will be described operations and effects of the vehicle body structure member according to the present embodiment.

As shown in FIG. 1, the present embodiment includes a rocker 12, a center pillar 14, and a cast coupling member 20 disposed at the intersection portion 18 of the floor cross member 16. The rocker 12 is divided into front and rear parts of the vehicle and includes a rocker front portion 24 and a rocker rear portion 26, and the coupling member 20 is capable of coupling the rocker front portion 24, the rocker rear portion 26, the center pillar 14, and the floor cross member 16, respectively. In the present embodiment, since the coupling member 20 is formed by casting, the degree of freedom in design of the coupling member 20 is improved.

Here, in the present embodiment, the coupling member 20 includes the first coupling portion 30, the second coupling portion 32, the third coupling portion 34, the fourth coupling portion 44, and the rib 46. The first coupling portion 30 is provided at a front end portion of the coupling member 20, and is coupled to the rear end portion 25 of the rocker front portion 24 in a state of being covered from the outside. The second coupling portion 32 is provided at a rear end portion of the coupling member 20, and is coupled to the front end portion 27 of the rocker rear portion 26 in a state of being covered from the outside.

The third coupling portion 34 is provided at a central portion and an upper end portion of the coupling member 20 in the vehicle front-rear direction, and is coupled to the lower end portion 15 of the center pillar 14 in a state of being covered from the outside. Further, the fourth coupling portion 44 is provided on the lower side than the third coupling portion 34, and is coupled to the end portion 17 of the floor cross member 16 in a state of being covered from the outside.

In the present embodiment, the rocker front portion 24, the rocker rear portion 26, the center pillar 14, the floor cross member 16, and the coupling member 20 are coupled to each other with a part of the coupling member 20 covered from the outside. Therefore, as a comparative example, although not shown, in the present embodiment, it is possible to improve the rigidity as compared with the case where the end faces of the members are brought into contact with each other in the intersection portion 18 and are welded, bonded, or the like.

Further, in the present embodiment, the rocker front portion 24, the rocker rear portion 26, the center pillar 14, and the floor cross member 16 are coupled to each other at the intersection portion 18 via the coupling member 20. Therefore, as compared with the case where the coupling member 20 is not provided, the rigidity of the coupling member 20 itself is added, and the rigidity of the intersection portion 18 can be improved.

Further, in the present embodiment, a rib 46 protruding along the extending direction of the floor cross member 16 is formed between the third coupling portion 34 and the fourth coupling portion 44. Thus, the rigidity of the coupling member 20 itself can be improved.

With the above-described configuration, in the present embodiment, the angle formed by the rocker 12, the center pillar 14, and the floor cross member 16 is maintained, and it is possible to suppress the deformation of the floor cross member 16 in the vehicle vertical direction due to the road surface input during the traveling of the vehicle.

Further, in the present embodiment, a bulk 28 is provided inside the floor cross member 16, and the bulk 28 is fastened together with the third coupling portion 34 and the floor cross member 16. This makes it possible to improve the rigidity of the floor cross member 16.

Therefore, in the present embodiment, it is possible to suppress the deformation of the floor cross member 16 in the vehicle vertical direction due to the road surface input during the traveling of the vehicle, and thus the seat vibration is suppressed and the ride comfort is improved. In addition, the steering stability is improved. Note that the bulk 28 is not necessarily required, and may be unnecessary by changing the shape or the like of the floor cross member 16, for example, by increasing the thickness of the floor cross member 16.

On the other hand, the floor cross member 16 includes a front wall portion 16A, a rear wall portion 16B, and an upper wall portion 16C, and ridge lines P and Q are provided at a boundary between the front wall portion 16A and the upper wall portion 16C and a boundary between the rear wall portion 16B and the upper wall portion 16C, respectively.

The ribs 46 are formed in front and rear directions in the vehicle front-rear direction substantially along the ridge lines P and Q, and extend so as to span the third coupling portion 34 and the fourth coupling portion 44. Since the ridge lines P and Q have higher rigidity than other portions of the floor cross member 16, by providing the ribs 46 along the ridge lines P and Q, the angle formed between the third coupling portion 34 and the fourth coupling portion 44 can be effectively maintained.

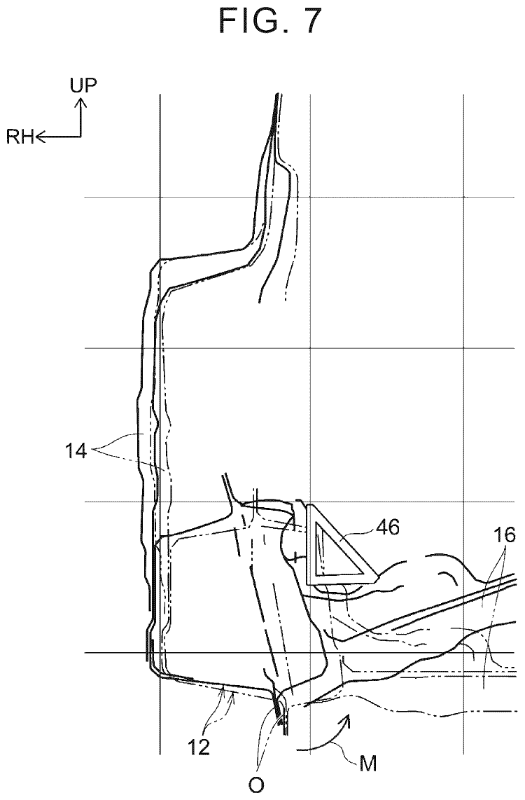

Therefore, in the present embodiment, as shown in FIG. 7, it is possible to suppress the floor cross member 16 being deformed toward the vehicle upper side by the moment M generated with the rocker 12 side as the starting point O by the road surface input during the traveling of the vehicle. Note that the solid line is a diagram showing a state in which the floor cross member is deformed, and the two-dot chain line is a diagram showing a state before the floor cross member is deformed.

In FIG. 7, so-called cross-sectional collapse occurs in the rocker 12, but in the present embodiment, as shown in FIGS. 1 and 2, a solid portion 36 is provided between the first coupling portion 30 and the second coupling portion 32. That is, in the rocker 12, a solid portion 36 is formed between the rocker front portion 24 and the rocker rear portion 26. Therefore, in the present embodiment, it is possible to suppress the cross-sectional collapse of the rocker 12 caused by the deformation of the floor cross member 16 in the vehicle vertical direction.

Further, in the present embodiment, the solid portion 36 is provided in the coupling member 20 coupled to the rocker 12, the center pillar 14, and the floor cross member 16, so that the intrusion path of the sound during the traveling of the vehicle is blocked and high-frequency road noise is reduced. In addition, the noise is reduced by reducing the sound generation of the floor panel 22. In addition, in the present embodiment, a foaming agent used for reducing noise is unnecessary, and the corresponding cost can be reduced. However, the solid portion 36 is not necessarily required.

Although an embodiment of the present disclosure has been described above, the present disclosure is not limited to such an embodiment, and the present disclosure may be used in combination with various modifications as appropriate. In addition, the present disclosure can be implemented in various forms without departing from the gist of the present disclosure.

### Additional Remarks

The following configurations may be appropriately combined to provide the vehicle body constituent member according to the present disclosure.

### Configuration 1

A vehicle body structure member comprises a coupling member disposed at an intersection portion of a rocker, a center pillar, and a floor cross member, the rocker being provided at an end portion of a floor panel in a vehicle width direction, extending in a vehicle front-rear direction, and configured to include a rocker front portion and a rocker rear portion divided in the vehicle front-rear direction, the center pillar extending in a vehicle up-down direction at a substantially central portion in the vehicle front-rear direction, the floor cross member extending along the vehicle width direction on the floor panel, and the coupling member being connectable to the rocker front portion, the rocker rear portion, the center pillar, and the floor cross member. The coupling member is configured to include: a first coupling portion provided at a front end portion of the coupling member in the vehicle front-rear direction and coupled to the rocker front portion in a state of covering a rear end portion of the rocker front portion in the vehicle front-rear direction from outside; a second coupling portion provided at a rear end portion of the coupling member in the vehicle front-rear direction and coupled to the rocker rear portion in a state of covering a front end portion of the rocker rear portion in the vehicle front-rear direction from outside; a third coupling portion provided at a center portion of the coupling member in the vehicle front-rear direction and an upper end portion of the coupling member in the vehicle up-down direction and coupled to the center pillar in a state of covering a lower end portion of the center pillar in the vehicle up-down direction from outside; a fourth coupling portion provided on a lower side in the vehicle up-down direction with respect to the third coupling portion and coupled to the floor cross member in a state of covering an end portion of the floor cross member in the vehicle width direction from outside; and a rib provided between the third coupling portion and the fourth coupling portion and protruding along an extending direction of the floor cross member.

### Configuration 2

The floor cross member has a substantially inverted U-shape in which a cross-sectional shape cut along a direction substantially orthogonal to the extending direction is an opening on the floor panel side, and the rib is provided in front and rear directions in the vehicle front-rear direction substantially along a ridge line of the floor cross member, and extends so as to bridge the third coupling portion and the fourth coupling portion.

### Configuration 3

A reinforcing member including the third coupling portion and fastened together with the third coupling portion and the floor cross member is provided inside the floor cross member.

### Configuration 4

A solid portion is provided between the first coupling portion and the second coupling portion.

What is claimed is:

1. A vehicle body structure member comprising
a coupling member disposed at an intersection portion of a rocker, a center pillar, and a floor cross member, the rocker being provided at an end portion of a floor panel in a vehicle width direction, extending in a vehicle front-rear direction, and configured to include a rocker front portion and a rocker rear portion divided in the vehicle front-rear direction, the center pillar extending in a vehicle up-down direction at a substantially central portion in the vehicle front-rear direction, the floor cross member extending along the vehicle width direction on the floor panel, and the coupling member being connectable to the rocker front portion, the rocker rear portion, the center pillar, and the floor cross member, wherein
the coupling member is configured to include:
a first coupling portion provided at a front end portion of the coupling member in the vehicle front-rear direction and coupled to the rocker front portion in a state of covering a rear end portion of the rocker front portion in the vehicle front-rear direction from outside;
a second coupling portion provided at a rear end portion of the coupling member in the vehicle front-rear direction and coupled to the rocker rear portion in a state of covering a front end portion of the rocker rear portion in the vehicle front-rear direction from outside;
a third coupling portion provided at a center portion of the coupling member in the vehicle front-rear direction and an upper end portion of the coupling member in the vehicle up-down direction and coupled to the center pillar in a state of covering a lower end portion of the center pillar in the vehicle up-down direction from outside;
a fourth coupling portion provided on a lower side in the vehicle up-down direction with respect to the third coupling portion and coupled to the floor cross member in a state of covering an end portion of the floor cross member in the vehicle width direction from outside; and
a rib provided between the third coupling portion and the fourth coupling portion and protruding along an extending direction of the floor cross member.

2. The vehicle body structure member according to claim 1, wherein:
the floor cross member has a cross section, when cut along a direction substantially orthogonal to the extending direction, in a substantially inverted U-shape that opens on a side of the floor panel; and
the rib is provided on front and rear sides in the vehicle front-rear direction substantially along a ridge line of the floor cross member, and extends between the third coupling portion and the fourth coupling portion.

3. The vehicle body structure member according to claim 1, wherein
a reinforcing member is provided inside the fourth coupling portion and the floor cross member, the reinforcing member being fastened together with the fourth coupling portion and the floor cross member.

4. The vehicle body structure member according to claim 1, wherein
a solid portion is provided between the first coupling portion and the second coupling portion.
